(19) United States
(12) Patent Application Publication
(10) Pub. No.: US 2022/0200176 A1
(43) Pub. Date: Jun. 23, 2022

(54) BRIDGE/SPLITTER CONNECTOR FOR CONFIGURING ELECTRICAL SIGNAL DISTRIBUTION NETWORK

(71) Applicant: Seasons 4, Inc., Toano, VA (US)

(72) Inventor: Jason Loomis, Decatur, GA (US)

(21) Appl. No.: 17/125,465

(22) Filed: Dec. 17, 2020

(51) Int. Cl. H01R 12/67; H01R 11/09; H01R 43/01; F21V 23/06

(52) U.S. Cl. CPC H01R 12/67; H01R 11/09; H01R 4/2416; F21V 23/06; H01R 43/01

(57) ABSTRACT

Apparatus and associated methods relate to a bridge/splitter connector for configuring an electrical signal distribution network. The bridge/splitter connector includes a body block and two cable retention covers, each configured to removably engage the body block. The body block has two cable channels, each configured to receive a multi-conductor flat cable therewithin. Each cable channel has a plurality of conductive piercing members laterally spaced apart from one another for piercing insulation of the multi-conductor flat cables received so as to conductively contact a corresponding one of a plurality of conductive wires of the multi-conductor flat cable. Each of the plurality of conductive piercing members of each cable channel is conductively coupled to a corresponding one of the plurality of piercing members of the other cable channel, The cable retention members are configured to retain the multi-conductor flat cables received within the cable channels when engaged with the body block.

### BACKGROUND

Configuring electrical signal distribution networks can be done by selecting from a suite of standard elements. For example, a vendor can provide a suite of different length cables, different types of connectors, etc. The specific requirements of the electrical signal distribution network can be met by selecting, from this suite of standard elements, those that most closely approximate these specific requirements. Because such suites of standard elements is finite, no suite can optimally meet the specific requirements of any electrical signal distribution network.

Another method of configuring an electrical signal distribution network is to custom build such a network. For example, and electrical signal distribution network can be constructed by cutting specific lengths of wire, and soldering these custom lengths of wires to connectors, other wires, or other elements of the electrical signal distribution network. Such customization is often performed by professionals trained in such arts.

### SUMMARY

Apparatus and associated methods relate to a bridge/splitter connector for configuring an electrical signal distribution network. The bridge/splitter connector includes a body block, and first and second cable retention members. The body block includes first and second cable channels. The first cable channel is located on a first side of the body block. The first cable channel is configured to receive a first multi-conductor flat cable therewithin. The first cable channel has a first plurality of conductive piercing members laterally spaced apart from one another within the first cable channel. Each of the first plurality of conductive piercing members configured to pierce insulation of the first multi-conductor flat cable received within the first cable channel so as to conductively contact a corresponding one of a first plurality of conductive wires of the first multi-conductor flat cable. The second cable channel is located on a second side of the body block. The second cable channel is configured to receive a second multi-conductor flat cable therewithin. The second cable channel has a second plurality of conductive piercing members laterally spaced apart from one another within the second cable channel. Each of the second plurality of conductive piercing members is configured to pierce insulation of the second multi-conductor flat cable received within the second cable channel so as to conductively contact a corresponding one of the second plurality of conductive wires of the second multi-conductor flat cable. Each of the first plurality of conductive piercing members of the first cable channel is conductively coupled to a corresponding one of the second plurality of piercing members of the second cable channel. The first cable retention cover is configured to removably engage the body block. The first cable retention cover is further configured to expose the first cable channel when removed and to retain the first multi-conductor flat cable received within the first cable channel when engaged with the body block. The second cable retention cover is configured to removably engage the body block. The second cable retention cover is further configured to expose the second cable channel when removed and to retain the second multi-conductor flat cable received within the second cable channel when engaged with the body block.

Some embodiments relate to a method for configuring an electrical signal distribution network. The method includes exposing, via removal of a first cable retention cover from a body block, a first cable channel located on a first side of the body block. The method then receives, via the first cable channel located on a first side of a body block, a first multi-conductor flat cable therewithin. Then, the method pierces, via a first plurality of conductive piercing members laterally spaced apart from one another within the first cable channel, insulation of the first multi-conductor flat cable received within the first cable channel so as to conductively contact a corresponding one of a first plurality of conductive wires of the first multi-conductor flat cable. Then the method retains, via engagement of the first cable retention cover to the body block, the first multi-conductor cable within the first cable channel. The method includes exposing, via removal of a second cable retention cover from a body block, a second cable channel located on a second side of the body block. The method then receives, via a second cable channel located on a second side of a body block, a first multi-conductor flat cable therewithin. Then, the method pierces, via a second plurality of conductive piercing members laterally spaced apart from one another within the second cable channel, insulation of the second multi-conductor flat cable received within the second cable channel so as to conductively contact a corresponding one of a second plurality of conductive wires of the second multi-conductor flat cable. Then the method retains, via engagement of the second cable retention cover to the body block, the second multi-conductor cable within the second cable channel. Each of the first plurality of conductive piercing members of the first cable channel is conductively coupled to a corresponding one of the second plurality of piercing members of the second cable channel.

### BRIEF DESCRIPTION OF THE DRAWINGS

FIG. 1 is a perspective view of an electrical signal distribution network configured using bridge/splitter connectors configured as a splice connector.

FIGS. 2A-2E shows various views of an exemplary embodiment of a bridge/splitter connector configured as a splice connector.

FIGS. 3A-3C are perspective views of an example of a bridge/splitter connector acting as bridge, splitter, and splice, respectively.

### DETAILED DESCRIPTION

Apparatus and associated methods relate to a bridge/splitter connector for configuring an electrical signal distribution network. The bridge/splitter connector includes a body block and two cable retention covers, each configured to removably engage the body block. The body block has two cable channels, each configured to receive a multi-conductor flat cable therewithin. Each cable channel has a plurality of conductive piercing members laterally spaced apart from one another for piercing insulation of the multi-conductor flat cables received so as to conductively contact a corresponding one of a plurality of conductive wires of the multi-conductor flat cable. Each of the plurality of conductive piercing members of each cable channel is conductively coupled to a corresponding one of the plurality of piercing members of the other cable channel, The cable retention members are configured to retain the multi-conductor flat cables received within the cable channels when engaged with the body block.

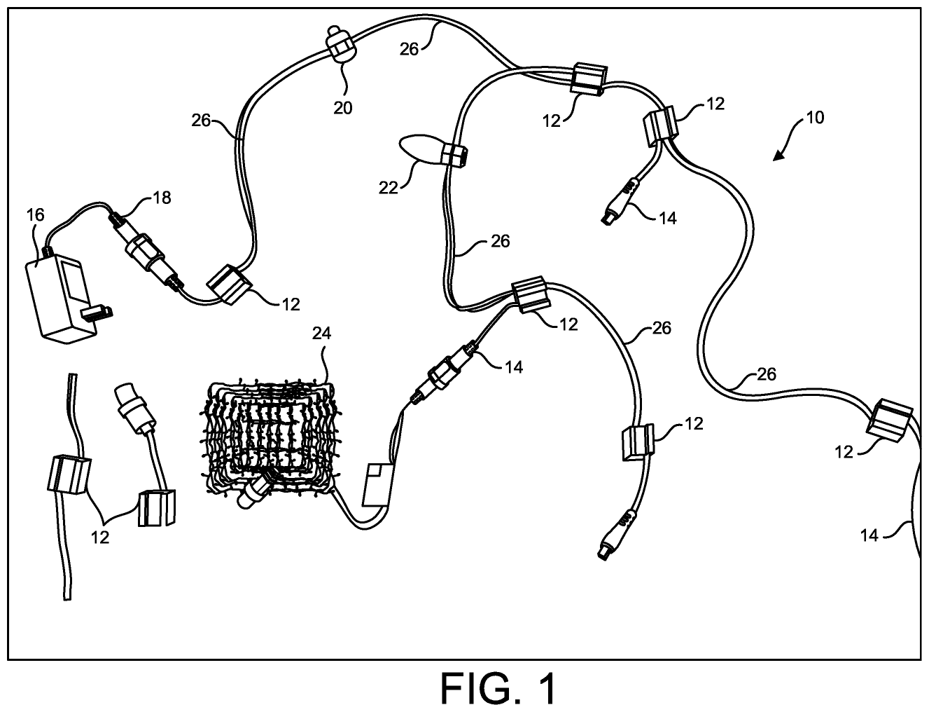

FIG. 1 is a perspective view of an electrical signal distribution network configured using bridge/splitter connectors. In FIG. 1, electrical signal distribution network 10 employs a number of bridge/splitter connectors 12 and extender/taps 14 to provide custom configuration of electrical signal distribution network 10. Electrical signal distribution network 10 includes power supply 16, starter lead 18, 10 mm wire-piercing bulb 20, C9 faceted wire-piercing bulb 22, and light string 24. Electrical power is provided to electrical signal distribution network 10 by power supply 16, which can be a transformer configured to convert standard high-voltage AC power into a low-voltage power, for example. Various low-voltage power standards can be used for electrical signal distribution network 10, such as, for example, 12 VDC, 18 VDC, 24 VDC, 12 VAC, 18 VAC, 24 VAC, etc. Segment lengths between various of the elements 16, 18, 20, 22 and 24 connected to electrical signal distribution network 10 can be customized based on the locations where such elements have been connected to multi-conductor flat cable sections 26. Branching customization of electrical signal distribution network 10 can be performed by selecting locations where bridge/splitter connectors 12 are connected to multi-conductor flat cable sections 26. Bridge/splitter connectors 12, as well as 10 mm wire-piercing bulbs 20 and C9 faceted wire-piercing bulbs 22, can connect with cable sections 26 at locations along their lengths, so as to provide custom configuration of electrical signal distribution network 10.

Each of bridge/splitter connectors 12 is configured to mechanically and electrically connect a first multi-conductor flat cable with a second multi-conductor flat cable. Furthermore, each of the first and second multi-conductor flat cables can extend either from one end or from two ends of the bridge/splitter connector 12, to which the first and second multi-conductor flat cables attach. For example, if both first and second multi-conductor flat cables extend from only one end (perhaps from opposite ends), then bridge/splitter connector 12 would function as a splice connector. If, however, a first multi-conductor flat cable extends from both ends of bridge/splitter connector 12, but a second multi-conductor flat cable extends only from one end of bridge/splitter connector 12, then bridge/splitter connector 12 would function as a tap connector. If both first and second multi-conductor flat cables extend from both ends of bridge/splitter connector 12, then bridge/splitter connector 12 would function as a bridge connector. In this way, bridge/splitter connector 12 can function as any of these three different types of connectors—splice, tap, or bridge. Bridge/splitter connectors 12, as well as 10 mm wire-piercing bulbs 20 and C9 faceted wire-piercing bulbs 22, can connect to cable sections 26 at any location along a length of multi-conductor flat cables as will be described in more detail below.

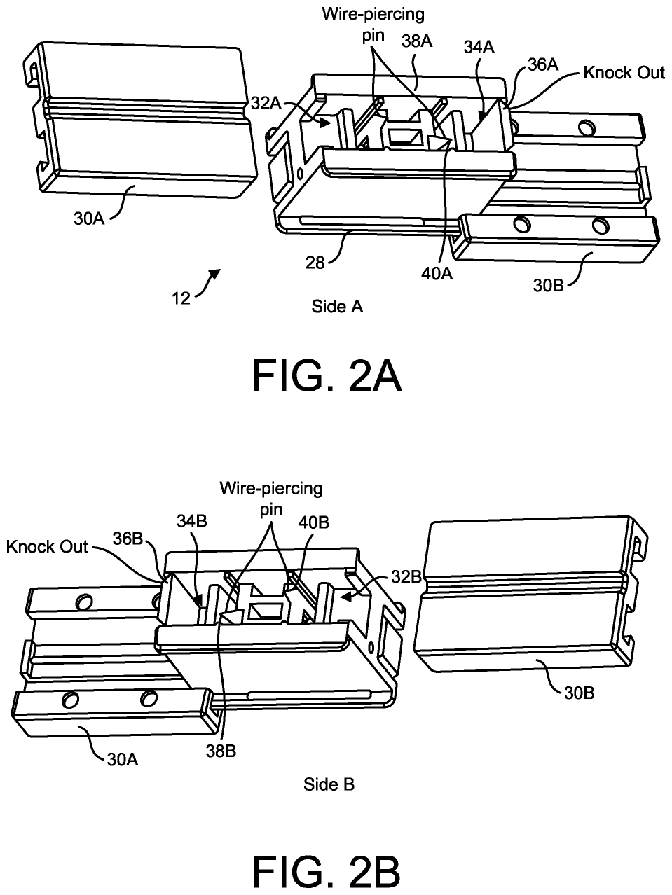

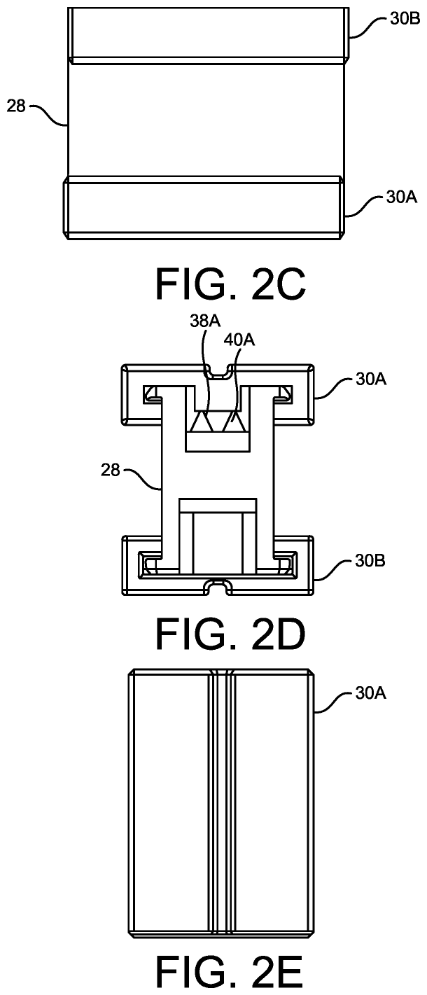

FIGS. 2A-2E shows various views of an exemplary embodiment of a bridge/splitter connector. FIG. 2A are perspective views of bridge/splitter connector 12 as depicted from opposite sides of bridge/splitter connector 12. In FIG. 2A, bridge/splitter connector 12 is shown as viewed from a side A vantage point, while in FIG. 2B, bridge/splitter connector 12 is shown as viewed from a side B vantage point. In FIGS. 2A and 2B, bridge/splitter connector 12 includes body block 28 and first and second cable retention covers 30A and 30B. First and second cable retention covers 30A and 30B are configured to removably engage body block 28. In the depicted embodiment, first and second retention covers 30A and 30B are configured to slidably engage body block 28. When removed, first and second cable retention covers 30A and 30B expose first and second cable channels 32A and 32B and first and second end cavities 34A and 34B, respectively. Each of first and second cable channels 32A and 32B is configured to receive a multi-conductor flat cables therewithin.

First and second end cavities 34A and 34B are contiguous with first and second cable channels 32A and 32B, respectively. Cut ends of the first and the second multi-conductor flat cables are configured to be received within first and second end cavities 34A and 34B, respectively, while the other ends of the first and the second multi-conductor flat cables pass through first and second cable channels 32A and 32B, respectively, and extend from body block 28. In the depicted embodiment, end cavities 34A and 34B are configured to receive cut ends of multi-conductor flat cables in a direction perpendicular to that of a longitudinal direction that portions of the multi-conductor flat cables that are retained within first and second cable channels 32A and 32B. Cut ends of the first and/or the second multi-conductor flat cables are received within first and second end cavities 34A and 34B only if such first and/or second multi-conductor flat cables are configured to extend only from one end of body block 28.

If, however, first and/or second multi-conductor flat cables are to extend from both ends of body block 28, then first and/or second removable tabs (e.g., knock-outs) 36A and/or 36B are removed from body block 28, so as to permit such a configuration. first and second removable tabs 36A and 36B are removably attached to body block 28. In some embodiments, when first and/or second removable tabs 36A and/or 36B are removed, they are removed in such a manner that doesn't permit re-attachment of first and/or second removable tabs 36A and/or 36B. In other embodiments, first and/or second removable tabs 36A and/or 36B are configured to be re-attached if needed.

Within first cable channels 32A are first plurality of conductive piercing members 38A and 40A. Similarly, within second cable channels 32B are second plurality of conductive piercing members 38B and 40B. Bridge/splitter connector 12 of the embodiment depicted in FIGS. 2A-2E is configured to provide connections between two-conductor flat cables, as each of first 38A and 40A and second 38B and 40B pluralities of conductive piercing members are two in number. In other embodiments, such pluralities can be three, or more in number so as to conductively couple to multi-conductor flat cables with a corresponding number of conductors. Each of the conductive piercing members of first 38A and 40A and second 38B and 40B pluralities of conductive piercing members is configured as laterally spaced apart elements from one another, so as to align with corresponding conductors of the multi-conductor flat cables received within first and second cable channels 32A and 32B.

First and second pluralities of conductive piercing members 38A and 40B are configured to pierce insulation of the multi-conductor flat cables received within first and second cable channels 32A and 32B, respectively. Such insulation is pierced so as to provide conductive contact between each conductive piercing member of first 38A and 40A and second 38B and 40B pluralities of conductive piercing members and a corresponding one of first and second pluralities of conductive wires 44A and 44B of first and second multi-conductor flat cables 26A and 26B, respectively. In some embodiments, each of first and second pluralities of conductive piercing members 38A and 40B are blades aligned with a longitudinal axis of the first and second cable channels, respectively. In other embodiments, each of first and second pluralities of conductive piercing members 38A and 40B are blades aligned with a transverse axis of the first and second cable channels, respectively.

After the multi-conductor flat cables are received within first and second cable channels 32A and 32B, first and second cable retention covers 30A and 30B can be returned to their engagement positions with body block 28. In some embodiments, the act of engaging first and second cable retention covers 30A and 30B can force the multi-conductor flat cables received within first and second cable channels 32A and 32B into first 38A and 40A and second 38B and 40B pluralities of conductive piercing members, respectively, thereby causing conductive contact between each conductive piercing member of first 38A and 40A and second 38B and 40B pluralities of conductive piercing members and corresponding conductors of the multi-conductor flat cables received within first and second cable channels 32A and 32B, respectively. Each of first plurality 38A and 40A of conductive piercing members of first cable channel 32A is conductively coupled to a corresponding one of second plurality 38B and 40B of piercing members of second cable channel 32B. In this way, each of conductors of the multi-conductor flat cable received within first cable channel 32A is conductively coupled to a corresponding one of the conductors of the multi-conductor flat cable received within second cable channel 32B.

Furthermore, in some embodiments, the multi-conductor flat cables received within first and second cable channels 32A and 32B are secured within first and second cable channels 32A and 32B, via various retention features. For example, first and second cable channels 32A and 32B and/or first and second cable retention covers 30A and 30B can include frictional surfaces or features, such as, for example, ridges, for inhibiting longitudinal translations of first and second multi-conductor flat cables 26A and 26B with respect to first and second cable channels 32A and 32B, when first and second cable retention covers 30A and 30B are engaged with body block 28. FIGS. 2C, 2D and 2E depict side elevation view, end elevation view and top plan view of bridge/splitter connector 12, which is depicted in FIGS. 2A and 2B.

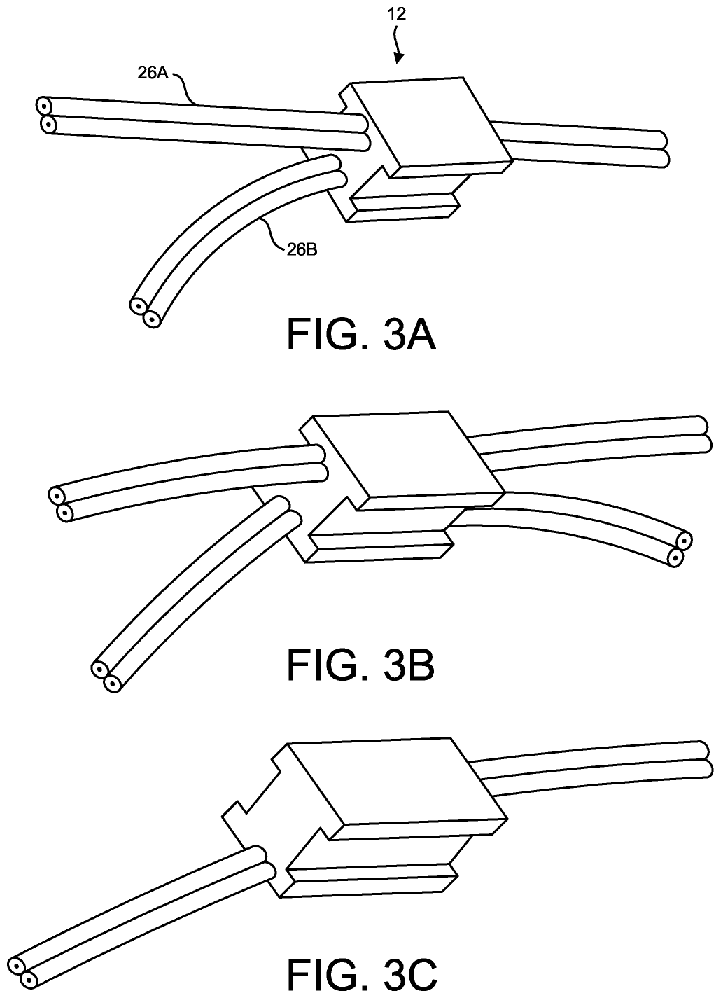

FIGS. 3A-3C are perspective views of an example of a bridge/splitter connector acting as bridge, splitter, and splice, respectively. In FIG. 3A, Bridge/splitter connector has first removeable tab 36A removed, so as to permit first multi-conductor cable 26A to extend beyond both ends of body block 28. Instead of receiving a cut end of first multi-conductor cable 26A into end cavity 34A, end cavity 34A is unoccupied, as first multi-conductor cable 26A extends beyond both ends of body block 28. Thus, with first removeable tab 36A removed, bridge/splitter connector 12 can mechanically and electrically engage first multi-conductor cable 26A anywhere along its length. In other words, with first removeable tab 36A removed, body block 28 is not limited to engagement with first multi-conductor cable 26A at a cut end of first multi-conductor cable 26A. In the embodiment depicted in FIG. 3A, second multi-conductor cable 26B engages second cable channel 32B at a cut end of second multi-conductor cable 26B. Thus, second cable channel 32B is configured as a tap off of first multi-conductor cable 32A.

In FIG. 3B, bridge/splitter connector 12 has both first and second removeable tabs 36A and 36B removed, so as to permit both first and second multi-conductor cable 32A and 32B to extend beyond both ends of body block 28. Instead of receiving a cut end of either first multi-conductor cables 26A or second multi-conductor cables 26B into end cavities 34A or 34B, respectively, end cavities 34A and 34B are unoccupied, as both first and second multi-conductor flat cables 26A and 26B extend beyond both ends of body block 28. Thus, with first and second removeable tabs 36A and 36B removed, body block 28 can mechanically and electrically engage both first and second multi-conductor cable 32A and 32B anywhere along their lengths. In other words, with first and second removeable tabs 36A and 36B removed, body block 28 is not limited to engagement with first and second multi-conductor cable 32A and 32B at cut ends of first and second multi-conductor cables 26A and 26B. In the FIG. 3B depicted embodiment, bridge/splitter connector 12 is configured as a bridge connector.

In FIG. 3C, neither of first removable tab 36A or second removable tab 36B has been removed from body block 28, such that bridge/splitter connector 12 couples to each of first and second multi-conductor flat cables 26A and 26B at an end. An end of first multi-conductor flat cable 26A is received into end cavity 34A. Similarly, an end of second multi-conductor flat cable 26B is received into end cavity 34B. In the FIG. 3C depicted embodiment, bridge/splitter connector 12 is configured as a splice connector.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A bridge/splitter connector for configuring an electrical signal distribution network, the bridge/splitter connector comprising:
a body block including:
a first cable channel located on a first side of the body block, the first cable channel configured to receive a first multi-conductor flat cable therewithin, the first cable channel having a first plurality of conductive piercing members laterally spaced apart from one another within the first cable channel, each of the first plurality of conductive piercing members configured to pierce insulation of the first multi-conductor flat cable received within the first cable channel so as to conductively contact a corresponding one of a first plurality of conductive wires of the first multi-conductor flat cable; and
a second cable channel located on a second side of the body block, the second cable channel configured to receive a second multi-conductor flat cable therewithin, the second cable channel having a second plurality of conductive piercing members laterally spaced apart from one another within the second cable channel, each of the second plurality of conductive piercing members configured to pierce insulation of the second multi-conductor flat cable received within the second cable channel so as to conductively contact a corresponding one of the a second plurality of conductive wires of the second multi-conductor flat cable,
wherein each of the first plurality of conductive piercing members of the first cable channel is conductively coupled to a corresponding one of the second plurality of piercing members of the second cable channel;
a first cable retention cover configured to removably engage the body block, the first cable retention cover further configured to expose the first cable channel when removed and to retain the first multi-conductor flat cable received within the first cable channel when engaged with the body block; and
a second cable retention cover configured to removably engage the body block, the second cable retention cover further configured to expose the second cable channel when removed and to retain the second multi-conductor flat cable received within the second cable channel when engaged with the body block.

2. The bridge/splitter connector of claim 1, wherein the body block further includes:
a first end cavity contiguous with the first cable channel, the first end cavity configured to receive an end of the first multi-conductor flat cable therewithin when the first multi-conductor cable is received within the first cable channel.

3. The bridge/splitter connector of claim 2, further comprising:
a first removable tab at an end of the first cable channel, the first removable tab barring the first multi-conductor cable from projecting beyond the end of the first cable channel when not removed, and permitting the first multi-conductor cable to project beyond the end of the first cable channel when removed.

4. The bridge/splitter connector of claim 1, wherein the body block further includes:
a second end cavity contiguous with the second cable channel, the second end cavity configured to receive an end of the second multi-conductor flat cable therewithin when the second multi-conductor cable is received within the second cable channel; and
a second removable tab at an end of the second cable channel, the second removable tab barring the second multi-conductor cable from projecting beyond the end of the second cable channel when not removed, and permitting the second multi-conductor cable to project beyond the end of the second cable channel when removed.

5. The bridge/splitter connector of claim 1, wherein the bridge/splitter connector has rotational symmetry about a transverse axis.

6. The bridge/splitter connector of claim 1, wherein each of the first plurality of conductive wires of the first multi-conductor flat cable are conductively coupled to corresponding ones of the second plurality of conductive wires of the second multi-conductor flat cable when both the first and second multi-conductor flat cables are received within the first and second cable channels, respectively.

7. The bridge/splitter connector of claim 1, wherein each of the first and second cable channels is configured to receive a two-conductor flat cable, and each of the first and second pluralities of conductive piercing members is a pair of conductive piercing members.

8. The bridge/splitter connector of claim 1, wherein each of the first and second pluralities of conductive piercing members are blades aligned with a longitudinal axis of the first and second cable channels, respectively.

9. The bridge/splitter connector of claim 1, wherein each of the first and second pluralities of conductive piercing members are blades aligned with a transverse axis of the first and second cable channels, respectively.

10. The bridge/splitter connector of claim 1, wherein the first and second cable retention covers are configured to slidably engage to the body block.

11. The bridge/splitter connector of claim 1, wherein the first side of the body block is opposite the second side of the body block.

12. A method for configuring an electrical signal distribution network, the method comprising:
exposing, via removal of a first cable retention cover from a body block, a first cable channel located on a first side of the body block;
receiving, via the first cable channel located on a first side of a body block, a first multi-conductor flat cable therewithin;
piercing, via a first plurality of conductive piercing members laterally spaced apart from one another within the first cable channel, insulation of the first multi-conductor flat cable received within the first cable channel so as to conductively contact a corresponding one of a first plurality of conductive wires of the first multi-conductor flat cable;
retaining, via engagement of the first cable retention cover to the body block, the first multi-conductor cable within the first cable channel;
exposing, via removal of a second cable retention cover from a body block, a second cable channel located on a second side of the body block;
receiving, via a second cable channel located on a second side of a body block, a first multi-conductor flat cable therewithin;
piercing, via a second plurality of conductive piercing members laterally spaced apart from one another within the second cable channel, insulation of the second multi-conductor flat cable received within the second cable channel so as to conductively contact a corresponding one of a second plurality of conductive wires of the second multi-conductor flat cable;
retaining, via engagement of the second cable retention cover to the body block, the second multi-conductor cable within the second cable channel;
wherein each of the first plurality of conductive piercing members of the first cable channel is conductively coupled to a corresponding one of the second plurality of piercing members of the second cable channel.

13. The method of claim 12, further comprising:
receiving, via a first end cavity at an end of the first cable channel, an end of the first multi-conductor flat cable therewithin, when the first multi-conductor cable is received within the first cable channel.

14. The method of claim 13, wherein the body block further includes a first removable tab at the end of the first cable channel, the first removable tab barring the first multi-conductor cable from projecting beyond the body block when not removed, and permitting the first multi-conductor cable to project beyond the body block when removed.

15. The method of claim 12, further comprising:
receiving, via a second end cavity at an end of the second cable channel, an end of the second multi-conductor flat cable therewithin, when the second multi-conductor cable is received within the second cable channel,
wherein the body block further includes a second removable tab at the end of the second cable channel, the second removable tab barring the second multi-conductor cable from projecting beyond the body block when not removed, and permitting the second multi-conductor cable to project beyond the body block when removed.

16. The method of claim 12, wherein the bridge/splitter connector has rotational symmetry about a transverse axis.

17. The method of claim 12, wherein each of the first plurality of conductive wires of the first multi-conductor flat cable are conductively coupled to corresponding ones of the second plurality of conductive wires of the second multi-conductor flat cable when both the first and second multi-conductor flat cables are received within the first and second cable channels, respectively.

18. The method of claim 12, wherein each of the first and second cable channels is configured to receive a two-conductor flat cable, and each of the first and second pluralities of conductive piercing members is a pair of conductive piercing members.

19. The method of claim 12, wherein each of the first and second pluralities of conductive piercing members are blades aligned with a longitudinal axis of the first and second cable channels, respectively.

20. The method of claim 12, wherein the first and second cable retention covers are configured to slidably engage to the body block.
